(19) United States
(12) Patent Application Publication
(10) Pub. No.: US 2023/0089384 A1
(43) Pub. Date: Mar. 23, 2023

(54) SYSTEM AND METHOD FOR AUTOMATICALLY ESTIMATING A SPEED OF AN AIRCRAFT DURING A FLIGHT OF THE AIRCRAFT

(71) Applicant: Airbus Operations (S.A.S.), Toulouse (FR)

(72) Inventor: Philippe Goupil, Toulouse (FR)

(21) Appl. No.: 17/941,597

(22) Filed: Sep. 9, 2022

(30) Foreign Application Priority Data
Sep. 15, 2021 (FR) 2109663

(51) Int. Cl. B64D 45/00; G06N 3/04

(52) U.S. Cl. CPC B64D 45/00; G06N 3/04

(57) ABSTRACT

A system and method for automatically estimating a speed of an aircraft during a flight of the aircraft includes a determining module to determine at least one quantity which is representative of a force exerted on at least one control surface of the aircraft, a calculating module to calculate at least one speed of the aircraft and a transmitting module to transmit the one or more speeds of the aircraft which are calculated by the calculating module to a user device. The system makes it possible to estimate a speed of the aircraft without having to use the total pressure.

### CROSS-REFERENCE TO RELATED APPLICATION

This application claims priority to French patent application number 2109663 filed on Sep. 15, 2021, the entire disclosure of which is incorporated by reference herein.

### TECHNICAL FIELD

The disclosure herein relates to a system and a method for automatically estimating at least one speed of an aircraft, in particular of a transport plane, in real time.

### BACKGROUND

Generally, in order to determine the speed of an aircraft during a flight, in particular a Mach number or a calibrated speed or rectified speed of V_{CAS} type (CAS standing for “calibrated airspeed”), measurements of the total air pressure are made using pitot probes and measurements of the static air pressure are made using dedicated sensors. The speed is then calculated using standard formulas using these measurements. Such a calculation therefore requires the total air pressure to be measured. Thus, if there is a desire to dispense with the use of sensors (total air pressure sensor or pitot probes) in order to save weight and to reduce the associated costs and the complexity of the processing chain, this standard solution is no longer able to determine the airspeed of the aircraft. Likewise, if there is a desire to increase the availability and the reliability of the standard total pressure measurements, for example in order to increase the autonomy of control even in the event of these sensors failing, it is desirable to have available dissimilar measurements or estimates.

The disclosure herein therefore relates to a system for automatically estimating at least one speed of an aircraft, without using the total pressure measurement, during a flight of the aircraft.

### SUMMARY

The subject of the disclosure herein is a system for automatically estimating the speed of an aircraft, in particular a transport plane, during a flight of the aircraft, without using the total pressure measurement.

According to the disclosure herein, the system comprises:
a determining module configured to determine at least one quantity which is representative of a force exerted on at least one control surface of the aircraft;
a calculating module configured to calculate at least one speed of the aircraft at least on the basis of the one or more quantities determined by the determining module;
a transmitting module configured to transmit the one or more speeds of the aircraft which are calculated by the calculating module to a user device.

The one or more quantities which are representative of a force each correspond to a pressure difference measured between two hydraulic chambers of an actuator which is intended to deflect a control surface of the aircraft.

The estimating system further comprises a collecting module configured to collect a plurality of flight parameters from the aircraft,

the one or more speeds of the aircraft being calculated by the calculating module on the basis of the overall pressure difference or the individual pressure differences and the plurality of flight parameters using a function in which the one or more speeds are a function of the one or more pressure differences, the function having the following expression:

V_{CAS}=f(θ),

in which
V_{CAS} corresponds to the one or more speeds to be determined,
θ corresponds to a parameter vector comprising the overall pressure difference or the individual pressure differences determined by the determining module and the plurality of flight parameters which are measured by the measuring module.

The one or more speeds are calculated on the basis of a neural network in which the one or more speeds to be calculated correspond to an output layer of the neural network and in which the overall pressure difference or the individual pressure differences and the plurality of flight parameters correspond to an input layer of the neural network, the neural network comprising fixed synaptic weights which are determined off-line.

Thus, by virtue of determining the force on at least one control surface, it is possible to estimate the speed of the aircraft without using the total pressure. The estimated speed may particularly be used in laws for guiding the aircraft, by a flight control computer of the aircraft.

In one embodiment, the determining module furthermore comprises at least one collecting submodule configured to collect an individual pressure difference from the actuator or from each actuator, the individual pressure difference being measured by a pressure difference measurement sensor of each actuator.

Advantageously, the determining module comprises a filtering submodule configured to filter the one or more individual pressure differences collected.

In one embodiment, the determining module additionally comprises a determining submodule configured to determine an overall pressure difference by calculating a mean, or indeed a median, or indeed a weighted mean of the individual pressure differences.

In a non-limiting example, the parameter vector has the following form:

θ=[ΔP;Pₛ;α;CONF;p;δₚ],

in which:
ΔP corresponds to the overall pressure difference or to the individual pressure differences determined by the determining module,
Pₛ corresponds to a static air pressure,
α corresponds to an angle of attack of the aircraft,
CONF corresponds to an aerodynamic configuration of slats and flaps of the aircraft,
p corresponds to an angle of roll of the aircraft,
δₚ corresponds to an angle of deflection of a control surface or of a position of a shaft of the actuator connected to the control surface of the aircraft.

The disclosure herein also relates to a method for automatically estimating a speed of an aircraft during a flight of the aircraft.

According to the disclosure herein, the method comprises at least the following steps:
a determining step, implemented by a determining module, consisting in determining at least one quantity which is representative of a force exerted on at least one control surface of the aircraft, the one or more quantities which are representative of a force each corresponding to a pressure difference measured between two hydraulic chambers of an actuator which is intended to deflect a control surface of the aircraft;
a calculating step, implemented by a calculating module, consisting in calculating at least one speed of the aircraft at least on the basis of the one or more quantities determined by the determining module;
a transmitting step, implemented by a transmitting module, consisting in transmitting the one or more speeds of the aircraft which are calculated in the calculating step to a user device.

The estimating method further comprises a collecting step, implemented by a collecting module, consisting in collecting a plurality of flight parameters from the aircraft.

The one or more speeds of the aircraft are calculated by the calculating step on the basis of the pressure differences and the plurality of flight parameters using a function in which the one or more speeds are a function of the one or more pressure differences, the function having the following expression:

V_{CAS}=f(θ),

in which
V_{CAS} corresponds to the one or more speeds to be determined,
θ corresponds to a parameter vector comprising the pressure differences determined by the determining step and the plurality of flight parameters which are measured by the collecting step;

the one or more speeds being calculated on the basis of a neural network in which the one or more speeds to be calculated correspond to an output layer of the neural network and in which the pressure differences and the plurality of flight parameters correspond to an input layer of the neural network, the neural network comprising fixed synaptic weights which are determined off-line through training on data sets which are determined for a plurality of flights of the aircraft.

The disclosure herein also relates to an aircraft, in particular a transport plane, comprising a system for automatically estimating a speed of an aircraft during a flight of the aircraft as specified above.

### BRIEF DESCRIPTION OF THE DRAWINGS

The appended figures will make it clearly understood how the disclosure herein may be embodied. In these figures, identical references denote similar elements.

FIG. 1 schematically shows one embodiment of the estimating system.

FIG. 2 schematically shows a cross section of an actuator and of a control surface which is deflected by the actuator.

FIG. 3 schematically shows a configuration of a neural network implemented by the estimating system in one embodiment of the disclosure herein.

FIG. 4 shows a graph comprising a thick curve corresponding to the actual speed V_{CAS} of the aircraft AC and a thin curve corresponding to the estimated speed V_{CAS} of the aircraft AC according to the embodiment of the disclosure herein.

FIG. 5 schematically shows the estimating method.

FIG. 6 schematically shows an aircraft which has an estimating system applied to the ailerons of the aircraft on board.

### DETAILED DESCRIPTION

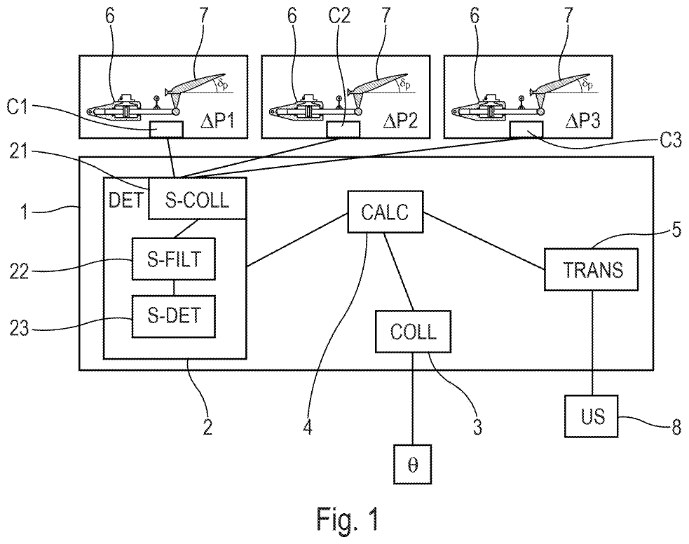

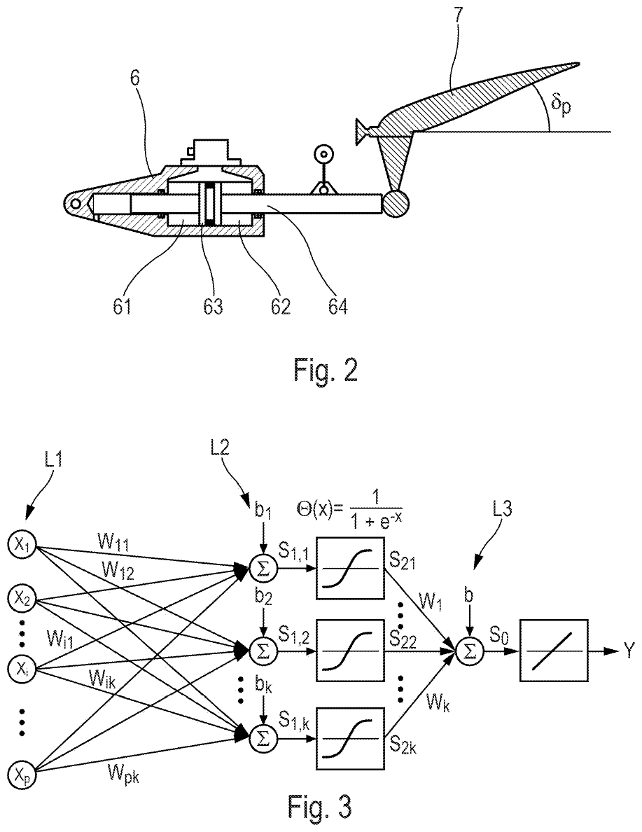

One embodiment of the system 1 for automatically estimating a speed of an aircraft AC during a flight of the aircraft AC, called the “estimating system 1” in the remainder of the description, is schematically shown in FIG. 1.

The estimating system 1 makes it possible to estimate a speed which is characteristic of the aircraft AC in real time.

The estimating system 1 comprises a determining module DET 2, a calculating module CALC 4 and a transmitting module TRANS 5. These various modules correspond, for example, to software modules employed by a processing unit of an avionic computer of the aircraft.

The determining module 2 is configured to determine at least one quantity which is representative of a force exerted on at least one control surface 7 of the aircraft AC.

An actuator 6 is configured to deflect the control surface 7. The quantity which is representative of a force may correspond to a pressure difference ΔP between two hydraulic chambers 61, 62 of an actuator 6 which is intended to deflect a control surface 7 of the aircraft AC. The actuator 6 is then equipped with a force sensor which is, in this case, a pressure difference sensor C1, C2, C3. This pressure difference sensor C1, C2, C3 makes it possible to measure the pressure difference ΔP1, ΔP2, ΔP3 between the two chambers 61 and 62 of this actuator 6, which are separated by a piston 63. The pressure difference ΔP1, ΔP2, ΔP3 will vary as a function of the movements of the shaft 64 of the actuator 6 but is also representative of the aerodynamic load or the force which is exerted on the control surface 7. Thus, in the case of a hydraulic actuator, the quantity which is representative of the force corresponds, for example, to a pressure difference ΔP1, ΔP2, ΔP3.

In the remainder of the description, a “pressure difference” will be referred to. However, it will be understood that the expression “pressure difference” may also have a more general meaning. It may mean any quantity which is representative of a force on a control surface. Thus, a suitable force sensor may be used to measure a quantity which is representative of the force exerted on the control surface 7 which is deflected by the actuator 6.

The estimating system 1 may be applied to other types of actuators equipped with a force sensor. For example, it may be applied to electro-hydrostatic actuators (EHAs) equipped with a motor, a pump and a force sensor, or even to electromechanical actuators (EMAs) also equipped with a force sensor.

The estimating system 1 may be used for one actuator 6 or a plurality of actuators 6.

The advantage of applying the estimating system 1 to a plurality of actuators 6 is being protected from the loss of an actuator or of a control surface 7 during the flight since the other actuators and control surfaces 7 remain.

Furthermore, using the estimating system 1 on a plurality of actuators 6 makes it possible to obtain a number of speed estimators which is equal to the number of actuators 6 used. If one of the estimators diverges markedly from the other estimators, this may be a sign of defective force sensor operation. The estimating system 1 may therefore also be used for sensor monitoring purposes.

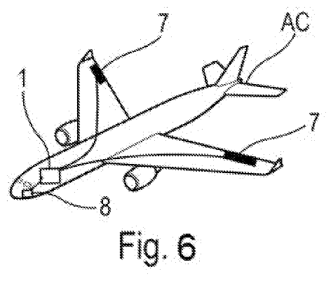

Preferably, the one or more control surfaces on which the estimating system 1 is used correspond to ailerons. Specifically, the ailerons are control surfaces which are heavily loaded aerodynamically, even at a low speed. The estimating system 1 may also be used on elevators or the rudder. However, the rudder is lightly loaded aerodynamically, in particular around the neutral position. Thus, it is preferable to apply the estimating system 1 to the ailerons or to the elevators. FIG. 6 shows an aircraft AC which has the estimating system 1 applied to the ailerons of the aircraft AC on board.

The determining module 2 may comprise at least one collecting submodule S-COLL 21 configured to collect an individual pressure difference ΔP1, ΔP2, ΔP3 from the actuator 6 or from each actuator 6. The individual pressure difference ΔP1, ΔP2, ΔP3 is measured by a pressure difference measurement sensor C1, C2, C3 of the actuator 6 or of each of the actuators 6.

The individual pressure difference ΔP1, ΔP2, ΔP3 corresponds to a pressure difference which is measured for an actuator 6.

The determining module 2 may also comprise a filtering submodule S-FILT 22 configured to filter the one or more individual pressure differences ΔP1, ΔP2, ΔP3 collected.

The measurements of individual pressure differences ΔP1, ΔP2, ΔP3 may be noisy as they may contain noise from the pressure difference sensor C1, C2, C3 as well as variations caused by the manoeuvres of the aircraft AC. However, these variations generate noise which remains centred around a low-frequency component which is representative of the aerodynamic force, itself a function of the speed V_{CAS} of the aircraft AC.

The filter used by the filtering submodule 22 may be a recursive infinite impulse response filter defined by a rational transfer function.

Furthermore, the determining module 2 may also comprise a determining submodule S-DET 23 configured to determine an overall pressure difference ΔP by calculating a mean, or indeed a median, or indeed a weighted mean of the individual pressure differences ΔP1, ΔP2, ΔP3.

In the case where the estimating system 1 is applied to a single actuator 6, the determining submodule 23 is not required.

The calculating module 4 is configured to calculate at least one speed V_{CAS} of the aircraft AC at least on the basis of the overall pressure difference ΔP or the individual pressure differences ΔP1, ΔP2, ΔP3 determined by the determining module 2.

The one or more estimated speeds may correspond to the calibrated speed V_{CAS}, to the Mach number or to the dynamic pressure of the aircraft AC.

The one or more speeds V_{CAS} of the aircraft AC may be filtered in order to improve precision as the speed of the aircraft AC is not very dynamic.

The transmitting module 5 is configured to transmit the one or more speeds V_{CAS} of the aircraft which are calculated by the calculating module 4 to a user device US 8.

The user device 8 may be a display device which is able to display the one or more speeds V_{CAS} estimated by the estimating system 1, or a control system of the aircraft, for example a flight control computer, which implements control laws using such one or more speeds V_{CAS} of the aircraft.

The estimating system 1 further comprises a collecting module COLL 3 configured to collect a plurality of flight parameters from the aircraft AC. The flight parameters are measured on board the aircraft AC.

The one or more speeds V_{CAS} of the aircraft are calculated by the calculating module 4 on the basis of the overall pressure difference ΔP or the individual pressure differences ΔP1, ΔP2, ΔP3 and the plurality of flight parameters using a function in which the one or more speeds V_{CAS} are a function of the overall pressure difference ΔP or the individual pressure differences ΔP1, ΔP2, ΔP3.

The function has the following expression:

V_{CAS}=f(θ),

in which:
V_{CAS} corresponds to the one or more speeds to be determined,
θ corresponds to a parameter vector comprising the overall pressure difference ΔP or the individual pressure differences ΔP1, ΔP2, ΔP3 determined by the determining module 4 and to the plurality of flight parameters which are measured by the measuring module 3.

In one particular non-limiting embodiment of the disclosure herein, the parameter vector θ may have the following form:

θ=[ΔP,Pₛ;α;CONF;p;δₚ],

in which:
ΔP corresponds to the overall pressure difference ΔP or to the individual pressure differences ΔP1, ΔP2, ΔP3,
Pₛ corresponds to a static air pressure,
α corresponds to an angle of attack of the aircraft AC,
CONF corresponds to an aerodynamic configuration of slats and flaps of the aircraft (AC),
p corresponds to an angle of roll of the aircraft AC,
δₚ corresponds to an angle of deflection of a control surface or of a position of a shaft of the actuator connected to the control surface of the aircraft AC.

The parameter vector corresponding to this particular embodiment is not chosen at random: it calls on knowledge of the physics of the flight of the aircraft. It originates from the non-obvious knowledge of a model of the hinge moment of the control surfaces.

Advantageously, the determining module 2, the calculating module 4, the transmitting module 5 and the collecting module 3 are software modules employed by at least one avionic computer of the aircraft.

The one or more speeds V_{CAS} are calculated on the basis of a neural network in which the one or more speeds V_{CAS} to be calculated correspond to an output layer L3 of the neural network and in which the parameter vector θ corresponds to an input layer L1 of the neural network (FIG. 3). The neurons of the neural network are connected to one another by synapses. A synaptic weight is attributed to each synapse. A synaptic weight corresponds to a multiplying factor of a synapse which connects two neurons of the neural network to one another. Each synaptic weight is fixed and calculated off-line; this means that all the synaptic weights are fixed once they have been calculated off-line. There is therefore no update of the synaptic weights during the implementation of the estimating system 1. This solution is, then, deterministic. The synaptic weights are calculated off-line through training on data sets which are determined for a plurality of flights of the aircraft AC, by virtue of iterative optimization methods, for example using a piece of digital computing software. The flights in the plurality of flights of the aircraft correspond, for example, to flights made during flight tests of the aircraft.

The neural network is used to perform non-linear regression. It makes it possible to estimate a highly non-linear relationship between its inputs and its outputs. This is advantageous as it would be very complicated, or even impossible, to use a physical model directly to estimate the speed because of the highly non-linear relationship between the inputs and the outputs.

In a preferred particular configuration, the neural network has three layers: the input layer L1, the output layer L3 and a hidden layer L2 between the input layer L1 and the output layer L3. FIG. 3 schematically shows the three-layer neural network.

The hidden layer L2 comprises a limited number of K neurons, so as to have a final complexity which is consistent with the limits of the on-board computers.

Non-limitingly, the maximum number K of neurons of the hidden layer L2 is less than 20.

The neural network used feeds the data forward only, without feedback. The neural network used is therefore a feedforward neural network.

Once the synaptic weights have been calculated, the neural network is implemented in the following way (FIG. 3).

The parameter vector θ corresponds to the input variables Xᵢ (i=1, . . . P).

The input variables Xᵢ are firstly normalized:
the input variables Xᵢ are lower-bounded by zero: Xᵢ=Xᵢ−min(Xᵢ),
the input variables are then normalized between −1 and +1:

$${X}_{i} = {X}_{i} * ( \frac{2}{max ( {X}_{i} )} ) - 1.$$

Then, each of the normalized input variables is multiplied by a synaptic weight Wᵢⱼ (i=1, . . . P; j=1, . . . K) and a bias is added in order to obtain a first weighting function for each of the K neurons of the hidden layer L2. This makes it possible to quantify the difference in contribution of each neuron.

For example, for the first of the K neurons of the hidden layer L2, the following first weighting function is obtained:

$${S}_{1 , 1} = {b}_{1} + {\sum }_{i = 1}^{P} {X}_{i} {W}_{i 1}$$

Generalizing to the K neurons, the following is obtained:

$${S}_{1 , j} = {b}_{j} + {\sum }_{i = 1}^{P} {X}_{i} {W}_{ji} ; ( i = 1 , … P ; j = 1 , … K )$$

Each neuron of the hidden layer L2 is activated by applying a bounded “activation function” Θ which makes it possible to better model non-linear behaviour in order to obtain a second weighting function. The activation function transforms a linear input into a non-linear output. The activation function corresponds, for example, to a sigmoid of the type:

$$Θ ( x ) = \frac{1}{1 + {e}^{- x}}$$

or to a “soft sign” function of the type

$$\frac{1}{1 + \vert x \vert} .$$

For example, for the first neuron, a following second weighting function is obtained by activating the first neuron:

S₂₁=Θ(S_{1,1})

Generalizing to the K neurons, the following is obtained:

S₂ⱼ=Θ(S_{1,j}); j=1, . . . K

The output layer L3 then linearly combines the weighting functions by multiplying the second weighting functions by the synaptic weights of the synapses connecting the neurons of the hidden layer L2 to the neurons of the output layer L3 and by adding a bias. The following function is therefore obtained:

$${S}_{0} = b + {\sum }_{j = 1}^{K} {W}_{j} {S}_{2 j}$$

The last operation consists in “denormalizing”, with reference to normalization, that is to say in making the output S₀ of the output layer L3 homogeneous with the quantity to be estimated, via a transformation:
the function S₀ is lower-bounded at zero: S₀=S₀−min(S₀),
the function S₀ is then normalized with respect to the maximum and minimum values of the speed V_{CAS} which is observed during training:

$$Y = {S}_{0} \frac{max ( {V}_{CAS} ) - min ( {V}_{CAS} )}{2} .$$

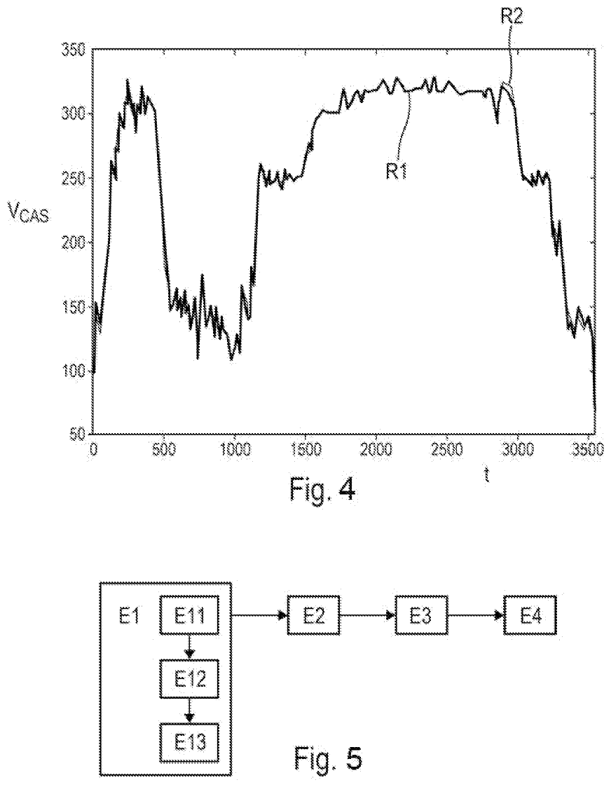

FIG. 4 shows a thick curve R1 corresponding to the actual speed V_{CAS} of the aircraft AC and a thin curve R2 corresponding to the estimated speed V_{CAS} of the aircraft AC when the speed V_{CAS} is estimated on the basis of a neural network. Comparing the curves R1 and R2, an excellent precision of the estimate of the speed V_{CAS}, in particular at a low speed, becomes clearly apparent.

The disclosure herein also relates to a method for automatically estimating the speed V_{CAS} of an aircraft AC during a flight of the aircraft AC, as shown in FIG. 5.

The method comprises at least the following steps:
a determining step E1, implemented by the determining module 2, consisting in determining at least one quantity which is representative of a force exerted on at least one control surface 7 of the aircraft AC;
a calculating step E3, implemented by the calculating module 4, consisting in calculating at least one speed V_{CAS} of the aircraft AC at least on the basis of the one or more quantities determined by the determining module 2;
a transmitting step E4, implemented by the transmitting module 5, consisting in transmitting the one or more speeds V_{CAS} of the aircraft which are calculated in the calculating step E3 to a user device.

The determining step E1 comprises a collecting substep E11, implemented by the collecting submodule 21, consisting in collecting an individual pressure difference ΔP1, ΔP2, ΔP3 from the actuator 6 or from each actuator 6, the individual pressure difference ΔP1, ΔP2, ΔP3 being measured by a pressure difference measurement sensor C1, C2, C3 of each actuator 6.

The determining step E1 may comprise a filtering substep E12, implemented by the filtering submodule 22, consisting in filtering the one or more individual pressure differences ΔP1, ΔP2, ΔP3 collected.

The determining step E1 may further comprise a determining substep E13, implemented by the determining submodule 23, consisting in determining an overall pressure difference ΔP by calculating a mean, or indeed a median, or indeed a weighted mean of the individual pressure differences ΔP1, ΔP2, ΔP3.

The method further comprises a collecting step E2, implemented by the collecting module 3, consisting in collecting a plurality of flight parameters from the aircraft AC.

In the calculating step E3, the one or more speeds of the aircraft are calculated on the basis of the pressure differences ΔP1, ΔP2, ΔP3 and the plurality of flight parameters using a function in which the one or more speeds (V_{CA}) are a function of the one or more pressure differences ΔP, the function having the following expression:

V_{CAS}=f(θ),

in which
V_{CAS} corresponds to the one or more speeds to be determined,
θ corresponds to a parameter vector comprising the pressure differences ΔP1, ΔP2, ΔP3 determined by the determining step E1 and the plurality of flight parameters which are measured by the collecting step E2;

the one or more speeds V_{CAS} being calculated on the basis of a neural network in which the one or more speeds V_{CAS} to be calculated correspond to an output layer of the neural network and in which the pressure differences ΔP1, ΔP2, ΔP3 and the plurality of flight parameters correspond to an input layer of the neural network, the neural network comprising fixed synaptic weights which are determined off-line through training on data sets which are determined for a plurality of flights of the aircraft AC.

The subject matter disclosed herein can be implemented in or with software in combination with hardware and/or firmware. For example, the subject matter described herein can be implemented in or with software executed by a processor or processing unit. In one example implementation, the subject matter described herein can be implemented using a computer readable medium having stored thereon computer executable instructions that when executed by a processor of a computer control the computer to perform steps. Example computer readable mediums suitable for implementing the subject matter described herein include non-transitory devices, such as disk memory devices, chip memory devices, programmable logic devices, and application specific integrated circuits. In addition, a computer readable medium that implements the subject matter described herein can be located on a single device or computing platform or can be distributed across multiple devices or computing platforms.

While at least one example embodiment of the invention(s) is disclosed herein, it should be understood that modifications, substitutions and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A system for automatically estimating a speed of an aircraft during a flight of the aircraft, comprising:
a determining module configured to determine at least one quantity which is representative of a force exerted on at least one control surface of the aircraft, the at least one quantity which is representative of a force corresponding to a pressure difference measured between two hydraulic chambers of an actuator which can deflect a control surface of the aircraft;
a calculating module configured to calculate at least one speed of the aircraft at least based on the at least one quantity determined by the determining module;
a transmitting module configured to transmit the at least one speed of the aircraft which is calculated by the calculating module to a user device;
a collecting module configured to collect a plurality of flight parameters from the aircraft;
the at least one speed of the aircraft being calculated by the calculating module based on the pressure difference and the plurality of flight parameters using a function in which the at least one speed is a function of the pressure difference, the function having a following expression:
V_{CAS}=f(θ),
in which
V_{CAS} corresponds to the at least one speed to be determined,
θ corresponds to a parameter vector comprising the pressure difference determined by the determining module and the plurality of flight parameters measured by the collecting module;
the at least one speed being calculated based on a neural network in which the at least one speed to be calculated corresponds to an output layer of the neural network and in which the pressure difference and the plurality of flight parameters correspond to an input layer of the neural network, the neural network comprising fixed synaptic weights which are determined off-line through training on data sets which are determined for a plurality of flights of the aircraft.

2. The system according to claim 1, wherein the determining module comprises at least one collecting submodule configured to collect an individual pressure difference from the actuator or from each actuator, the individual pressure difference being measured by a pressure difference measurement sensor of each actuator.

3. The system according to claim 1, wherein the determining module comprises a filtering submodule configured to filter one or more individual pressure differences collected.

4. The system according to claim 2, wherein the determining module comprises a determining submodule configured to determine an overall pressure difference by calculating a mean, or a median, or a weighted mean of the individual pressure difference.

5. The system according to claim 1, wherein the parameter vector (θ) has a following form:
θ=[ΔP;Pₛ;α;CONF;p;δₚ],
in which:
ΔP corresponds to overall pressure difference or to the individual pressure differences determined by the determining module,
Pₛ corresponds to a static air pressure,
α corresponds to an angle of attack of the aircraft,
CONF corresponds to an aerodynamic configuration of slats and flaps of the aircraft,
p corresponds to an angle of roll of the aircraft,
δₚ corresponds to an angle of deflection of a control surface or of a position of a shaft of the actuator connected to the control surface of the aircraft.

6. The system according to claim 1, wherein the neural network has three layers: the input layer, the output layer and a hidden layer between the input layer and the output layer.

7. The system according to claim 6, wherein the hidden layer comprises a maximum number of neurons which is less than 20.

8. The system according to claim 6, wherein the neural network is a feedforward neural network.

9. The system according to claim 6, wherein the neural network is implemented by:
the pressure difference and the plurality of flight parameters corresponding to input variables are normalized,
each of the normalized input variables is multiplied by a synaptic weight and a bias is added to obtain a first weighting function for each of the neurons of the hidden layer,
each neuron of the hidden layer is activated by applying an activation function which is bounded to obtain a second weighting function,
the output layer linearly combines the weighting functions by multiplying the second weighting functions by the synaptic weights of the synapses connecting the neurons of the hidden layer to the neurons of the output layer and by adding a bias to obtain an output function,
a last operation comprises making the output function of the output layer homogeneous with a quantity to be estimated corresponding to the speed.

10. The system according to claim 1, wherein the input variables are normalized by:
the input variables are lower-bounded by zero,
the input variables are then normalized between −1 and +1,
the output function of the output layer being made homogeneous by:
the output function is lower-bounded at zero,
the output function is then normalized with respect to maximum and minimum values of the speed which is observed during training.

11. The system according to claim 9, wherein the activation function corresponds to a sigmoid of a type
$$Θ ( x ) = \frac{1}{1 + {e}^{- x}}$$
or to a “soft sign” function of a type
$$Θ ( x ) = \frac{1}{1 + \vert x \vert} .$$

12. A method for automatically estimating a speed of an aircraft during a flight of the aircraft, comprising:
a determining step, implemented by a determining module, comprising determining at least one quantity which is representative of a force exerted on at least one control surface of the aircraft, the at least one quantity which is representative of a force each corresponding to a pressure difference measured between two hydraulic chambers of an actuator to deflect a control surface of the aircraft;
a calculating step, implemented by a calculating module, comprising calculating at least one speed of the aircraft at least based on the at least one quantity determined by the determining module;
a transmitting step, implemented by a transmitting module, comprising transmitting the at least one speed of the aircraft calculated in the calculating step to a user device;
a collecting step, implemented by a collecting module, comprising collecting a plurality of flight parameters from the aircraft,
the at least one speed of the aircraft calculated by the calculating step based on the pressure difference and the plurality of flight parameters using a function in which the at least one speed is a function of the pressure difference, the function having the following expression:
V_{CAS}=f(θ),
in which
V_{CAS} corresponds to the at least one speed to be determined,
θ corresponds to a parameter vector comprising the pressure difference determined by the determining step and the plurality of flight parameters which are measured by the collecting step;
the at least one speed being calculated based on a neural network in which the at least one speed to be calculated corresponds to an output layer of the neural network and in which the pressure difference and the plurality of flight parameters correspond to an input layer of the neural network, the neural network comprising fixed synaptic weights which are determined off-line through training on data sets which are determined for a plurality of flights of the aircraft.

13. An aircraft comprising a system for automatically estimating a speed of an aircraft during a flight of the aircraft according to claim 1.
